(19) United States
(12) Patent Application Publication
(10) Pub. No.: US 2026/0001816 A1
(43) Pub. Date: Jan. 1, 2026

(54) DENSE CERAMIC-METAL COMPOSITES AND COMPONENTS AND METHODS OF MANUFACTURING

(71) Applicant: Purdue Research Foundation, West Lafayette, IN (US)

(72) Inventors: Kenneth H. Sandhage, Lafayette, IN (US); Mario Raul Caccia, Butte, MT (US)

(21) Appl. No.: 18/648,701

(22) Filed: Apr. 29, 2024

Related U.S. Application Data
(60) Provisional application No. 63/462,654, filed on Apr. 28, 2023.

(51) Int. Cl. C04B 35/65; C04B 35/48; C04B 35/657

(52) U.S. Cl. CPC C04B 35/651; C04B 35/48; C04B 35/657; C04B 2235/3244; C04B 2235/3251; C04B 2235/404; C04B 2235/616; C04B 2235/9607; C04B 2235/9669

(57) ABSTRACT

Dense ceramic-metal composites and components and methods of manufacturing. A method of manufacturing a ceramic-metal composite includes forming a metal containing component into preform having a desired shape and dimensions with pores therein, infiltrating the pores of the preform with a multi-element liquid reactant, and reacting the metal containing component with the multi-element liquid reactant in a displacement reaction at an elevated temperature to form a less porous ceramic-metal composite.

### CROSS-REFERENCE TO RELATED APPLICATIONS

This application claims the benefit of provisional U.S. Patent Application No. 63/462,654 filed Apr. 28, 2023, the contents of which are incorporated herein by reference.

### BACKGROUND OF THE INVENTION

The invention generally relates to methods of manufacturing a ceramic-metal composite and components, and ceramic-metal composites and components made thereby.

Current turbine blades for high temperature operation are typically made of single crystals of nickel-based superalloys that possess internal cooling channels and that contain a thermal barrier coating. The thermal barrier coating and internal cooling channels are used to lower the temperature of the nickel-based superalloy during operation of the turbine, so that the nickel-based superalloy can retain sufficiently high stiffness, creep resistance, and fracture toughness while operating the jet engine at high temperatures. In order to further increase the efficiency and performance of turbine engines, there is a desire to operate such turbine engines at higher temperatures than are presently used which, in turn, provides a strong desire to develop turbine blades (and other components in the hot section of the turbine) made of the ceramic composite materials of the present invention which are capable of operation at higher temperatures with enhanced resistances to creep, fracture, or plastic deformation than are possible with current metal alloy-based turbine blade materials. There is also a strong desire to produce such higher temperature turbine blades in complex shapes via a cost-effective process. However, conventional commercial manufacturing processes for generating dense, high-temperature ceramic composites involve the use of expensive processes (e.g., high-pressure hot pressing or hot-isostatic pressing at high temperatures) and involve appreciable shrinkages with a reduction in the yields of complex-shaped components with desired shapes and dimensions. Therefore, it would be desirable to have a method of manufacturing ceramic-metal composites having desired shapes and dimensions and components made of such ceramic-metal composites that overcome one or more of these limitations.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, methods of manufacturing ceramic-metal composites, methods of manufacturing high-temperature components, ceramic-metal composites, and components formed of the ceramic-metal composites.

According to a nonlimiting aspect, a method of manufacturing a ceramic-metal composite includes forming a metal containing component into a preform having a desired shape and dimensions with pores therein, infiltrating the pores in the preform with a multi-element liquid reactant, and reacting the metal containing component with the multi-element liquid reactant in a displacement reaction at an elevated temperature to form a less porous ceramic-metal composite with the desired shape and dimensions.

According to another nonlimiting aspect, a ceramic-metal composite manufactured according to the method is provided.

According to yet another nonlimiting aspect, a component formed of the ceramic-metal composite is provided.

According to a further nonlimiting aspect, a method of manufacturing a high-temperature component of a high-temperature system, wherein the high-temperature component has a desired shape and dimensions. The method includes forming a metal containing component into a preform with pores therein wherein the preform has a shape and dimensions that are substantially similar to the desired shape and dimensions of the high-temperature component, infiltrating the pores in the preform with a multi-element liquid reactant, reacting the metal containing component with the multi-element liquid reactant in a displacement reaction at an elevated temperature to form a ceramic-metal composite having a shape and dimensions that are substantially similar to the shape and dimensions of the preform; and fine adjusting the shape and dimensions of the ceramic-metal composite to have the desired shape and dimensions of the high-temperature component.

Technical aspects of methods, ceramic-metal composites, and/or components as described above may include the capability of providing improvements in the manufacture of high-temperature components, especially such components that have complex shapes. Such improvements may provide cost-effective, net-shape processes for manufacturing high-temperature, complex-shaped, dense ceramic/metal composites with properties suitable for use in high-temperature aerospace (including hypersonic), power production, and manufacturing systems.

These and other aspects, arrangements, features, and/or technical effects will become apparent upon detailed inspection of the figures and the following description.

### BRIEF DESCRIPTION OF THE DRAWINGS

FIG. 1 is a schematic representation of a method including a pore-filling reactive infiltration process according to certain nonlimiting aspects of the invention.

FIG. 2 is a schematic representation of another method according to certain nonlimiting aspects of the invention.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of the embodiment(s) to which the drawings relate. The following detailed description also describes certain investigations relating to the embodiment(s) depicted in the drawings, and identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

Certain methods for manufacturing ceramic and ceramic composite components, and the components made thereby, related generally to the subject matter of the present invention are reported in U.S. patent application Ser. No. 16/338,734 (published as U.S. Patent Application Publication No. 2019/0381600 A1), Ser. No. 16/503,117 (published as U.S. Patent Application Publication No. 2020/010928 A1), and Ser. No. 17/892,091 (published as U.S. Patent Application Publication No. 2022/411336 A1), the contents of each of which are incorporated herein by reference.

The following describes net-shape and net-size methods capable of fabricating mechanically-robust materials capable of use in components in high-temperature systems, and describes the materials and components made thereby. Such methods, materials, and components preferably encompass dense ceramic-metal composites manufactured via shape-preserving reactive liquid infiltration of porous metal preforms. According to preferred but nonlimiting aspects of the invention, such ceramic-metal composites and ceramic-metal composite components, include for example, ceramic-refractory metal composite components suitable for high temperature applications, methods of manufacturing such components, and systems including such components.

Particularly preferred embodiments of the invention relate to the fabrication of high-melting, stiff, erosion-resistant, fracture-resistant, and plastic-deformation-resistant ceramic-metal composites and ceramic-metal composite components for particular use in components in high-temperature systems. Such high-temperature systems include, but are not limited to, systems for transportation, propulsion, power production, and manufacturing. Some nonlimiting examples of such components include high-temperature components, including but not limited to, leading edges and engine components of aircraft, spacecraft, and missiles exposed to hypersonic conditions at temperatures exceeding 500° C. and up to at least 2000° C. and to high-temperature engine components (such as turbine blades, compressors, shrouds, combustion chambers, valves) for non-hypersonic aircraft and for non-hypersonic power production, as nonlimiting examples, turbine blades for use in jet engine turbines and turbines for ground-based power plants.

According to another nonlimiting aspect of the invention, the components may be manufactured to have a desired shape and dimensions and exhibit desirable high-temperature properties, such as high melting temperatures, stiffness, creep resistance, fracture resistance, erosion resistance, plastic deformation resistance, thermal cycling resistance, thermal shock resistance, corrosion resistance, thermal conductivity, and electrical conductivity at temperatures of at least 500° C. and up to at least 2000° C. As used herein, the terms near-net shape and near-net size may be used to refer to an object with a form factor having a shape and size (dimensions) that are nearly (approximately or similar to), though perhaps not exactly, the same shape and dimensions as the final desired shape and dimensions, respectively, of a particular component or other object. Typically, though not necessarily, the near-net shape and size is slightly larger than the desired final shape and dimensions to allow for easy fine adjusting, such as by milling (e.g., sanding or lathing or other removal technique) or additive (e.g., adding one or more coating layers) to the exact desired final shape and dimensions. For example, a turbine blade may have a (final) desired shape and dimensions, and an intermediate form of the turbine blade may be formed with the methods of the present invention to have substantially, although possibly not exactly, the same shape and size as the final turbine blade shape and dimensions, thereby having a near-net shape and a near-net size that is nearly the same as the final desired shape and dimensions of the turbine blade. Thus, the intermediate form of the turbine blade having near-net shape and size may require only minimal final fine-shaping, such as sanding or milling, to achieve the desired final shape and dimensions.

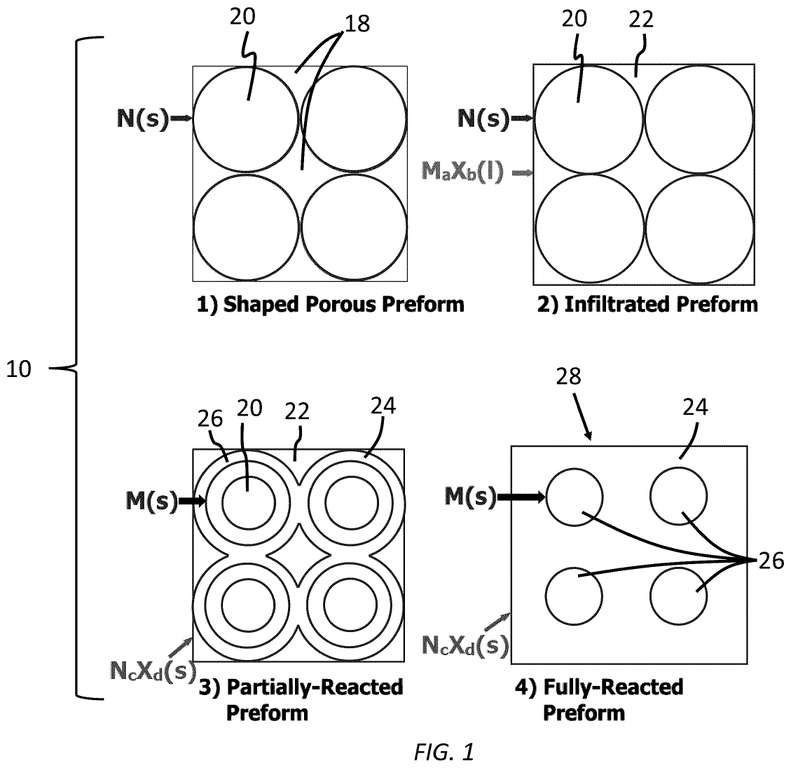

FIG. 1 illustrates a nonlimiting example of a method 10 of forming a dense ceramic-metal composite according to certain principles of the present invention. The method 10 includes at least four steps, designated in FIG. 1 as steps 1, 2, 3, and 4. In step 1, a porous preform 20 made of a metal containing component, such as a solid metal or solid metallic alloy or solid intermetallic compound (or a mixture containing a solid metal reactant), with an appropriate composition, pores 18, pore fraction, and overall shape is synthesized or obtained. Next, infiltration is performed at step 2. In this step, the pores 18 of the porous preform 20 are infiltrated with a multi-element liquid reactant 22 (which includes, but is not limited to, a molten oxide, a molten nitride, a molten carbide, a molten boride, and a molten fluoride) at an elevated temperature. A reaction occurs during steps 3 to 4. In these steps, the multi-element liquid reactant 22 is allowed to react partially (step 3) or completely (step 4) with the solid preform 20 at an elevated temperature to produce a less porous (denser) shaped body 28 containing the desired solid ceramic and metal phase(s).

The reaction in steps 3 to 4 is a displacement reaction of the following general type between the multi-element liquid reactant 22 (MₐX_{b}(l)) and the solid shaped porous preform 20 made of a metal, N(s):

$$( d / bc ) {M}_{a} {X}_{b} ( 1 ) + N ( s ) = ( 1 / c ) {N}_{c} {X}_{d} ( s ) + ( ad / bc ) M ( s ) , \qquad Eq . ( 1 )$$

where N_{c}X_{d}(s) is the solid reaction product 24, X is a metalloid element, such as, for example, oxygen, nitrogen, carbon, boron, fluorine, etc., M(s) is the solid reaction product 26, and a, b, c, and d are molar coefficients. Other metalloids whose properties fall partway between those that are characteristic of metals and those that are characteristic of nonmetals and can alloy with other metals, such as, silicon, germanium, arsenic, antimony, tellurium, polonium, could be used. The pore fraction of the porous preform 20 is tailored so that the reaction-induced increase in solid volume can compensate partially or completely for such porosity, for example at least partially or fully filling the voids created by the pores 18 in the porous preform 20. It will be understood that the porous preform 20 need only be sufficiently dimensionally stable to resist the capillary action of the infiltrated liquid reactant 22.

In the represented method 10, reactions are chosen such that the solid reaction products 24 and 26 of the reaction (i.e., (1/c) moles of N_{c}X_{d}(s) and (ad/bc) moles of M(s)) possess a volume that is larger than the volume of the solid reactant of the preform 20 (1 mole of N(s)); that is,

$$( 1 / c ) {V}_{m} [ {N}_{c} {X}_{d} ( s ) ] + ( ad / bc ) {V}_{m} [ M ( s ) ] > {V}_{m} [ N ( s ) ] ,$$

where Vₘ[N_{c}X_{d}(s)] is the molar volume of the solid reaction product 24, N_{c}X_{d}(s); Vₘ[M(s)] is the molar volume of the solid reaction product 26, M(s); and Vₘ[N(s)] is the molar volume of the solid reactant, N(s), of the preform 20. Such an increase in solid volume upon reaction is used to fill the prior pores 18 within the starting, shaped, porous N(s) preform 20; that is, the increase in solid volume upon reaction is used to compensate for the prior pore volume of the N(s)-bearing preform 20. The reactions are chosen such that the multi-element liquid reactant 22, MₐX_{b}(l), wets and infiltrates into the porous preform 20 made of a metal or metallic alloy or intermetallic compound (or a mixture containing a solid metal reactant).

Example 1. A first nonlimiting example of the method 10 of the present invention is the formation of a ZrO₂/Nb composite 28 via the reactive infiltration of a Nb₂O₅ liquid reactant 22 into a shaped, porous Zr preform 20. At step 2, a rigid porous solid Zr(s) preform 20 is infiltrated with a Nb₂O₅-bearing (multi-element) liquid reactant 22. At step 3, the liquid reactant 22 has partially reacted to yield the ZrO₂ solid reaction product 24 and the Nb solid reaction product 26. At step 4, the Zr(s) has been consumed to yield a dense composite 28 made completely of the ZrO₂ and Nb solid reaction products, 24 and 26, respectively. The associated pore-filling reaction for this example is

$$( 2 / 5 ) N {b}_{2} {O}_{5} ( 1 ) + Z r ( s ) = Z r {O}_{2} ( s ) + ( 4 / 5 ) N b ( s ) , \qquad Eq . ( 2 )$$

where a Nb₂O₅-bearing liquid reactant 22 infiltrates into a porous Zr(s) preform 20 and reacts to yield a dense, shape-preserved ZrO₂/Nb composite 28. For this example, the reaction of Eq. (2) would be conducted: i) above the solidus temperature of Nb₂O₅ (1512° C.) and ii) below the melting point of the lowest-melting solid phase in reaction, which is Zr(s) (melting temperature of 1855° C.). This reaction is quite thermodynamically favored. For example, at 1800° C., the standard Gibbs free energy of reaction, DG°ᵣₓₙ₍₂₎[1800° C.], is −297.8 kJ/mol. The solid products of this reaction (1 mole of monoclinic ZrO₂(s) and 0.80 moles of Nb(s)) possess a combined volume that is 2.11 times larger than the volume of the solid reactant (1 mole of Zr(s)). (Note: the room temperature molar volumes of monoclinic ZrO₂(s), Nb(s) and Zr(s) are 21.19 cm³/mole, 10.85 cm³/mole, and 14.17 cm³/mole, respectively.) The two solid reaction products 24 and 26, N_{c}X_{d} and M, possess a combined volume that is larger than the volume of the N solid reactant in the preform 20. Hence, a rigid porous N(s) preform 20 can be converted into a dense N_{c}X_{d}/M-based composite 28, by the infiltration and reaction of N(s) with the MₐX_{b}-bearing liquid reactant 22, with little change in external dimensions.

Example 2. A second nonlimiting example of the present invention is the formation of a ZrO₂/Nb composite 28 via the reactive infiltration of a Nb₂O₅-bearing liquid reactant 22 into a shaped, porous Zr preform 20. The associated pore-filling reaction for this example is:

$$( 2 / 5 ) \{ N {b}_{2} {O}_{5} \} ( 1 ) + Z r ( s ) = Z r {O}_{2} ( s ) + ( 4 / 5 ) N b ( s ) , \qquad Eq . ( 3 )$$

where {Nb₂O₅}(l) refers a multicomponent oxide liquid reactant 22 that contains dissolved Nb₂0₅. Examples of a multicomponent oxide liquid reactant 22 that contain dissolved Nb₂0₅ include a CaO—Nb₂O₅ liquid solution (such as a 6 wt. % CaO-94 wt. % Nb₂O₅ composition with a eutectic temperature of 1371° C., or a 26 mole % SrO-74 mole % Nb₂O₅ composition with a eutectic temperature of 1320° C.). For this example, the reaction of Eq. (3) would be conducted: i) above the solidus temperature of the Nb₂O₅-bearing liquid reactant 22 (e.g., above 1371° C. for a 6 wt. % CaO-94 wt. % Nb₂O₅ liquid precursor) and ii) below the melting point of Zr (1855° C.).

Example 3. A third nonlimiting example of the method 10 of the present invention is the formation of a HfO₂/Nb composite 28 via the reactive infiltration of a Nb₂O₅ liquid reactant 22 into a shaped, porous Hf preform 20. The associated pore-filling reaction for this example is:

$$( 2 / 5 ) N {b}_{2} {O}_{5} ( 1 ) + H f ( s ) = H f {O}_{2} ( s ) + ( 4 / 5 ) N b ( s ) . \qquad Eq . ( 4 )$$

For this example, the reaction of Eq. (4) would be conducted: i) above the solidus temperature of Nb₂O₅ (1512° C.) and ii) below the melting point of the lowest-melting solid phase in reaction (4), which is Hf(s) (melting temperature of 2231° C.). This reaction is quite thermodynamically favored. For example, at 1800° C., the standard Gibbs free energy of reaction, DG°ᵣₓₙ₍₄₎[1800° C.], is −362.5 kJ/mol. The solid reaction products 24 and 26 of this reaction (1 mole of HfO₂(s) and 0.80 moles of Nb(s)) possess a combined volume that is 2.19 times larger than the volume of the solid reactant 20 (1 mole of Hf(s)). (Note: the room temperature molar volumes of monoclinic HfO₂(s), Nb(s) and Hf(s) are 20.82 cm³/mole, 10.85 cm³/mole, and 13.48 cm³/mole, respectively.)

Example 4. A fourth nonlimiting example of the method 10 of the present invention is the formation of a HfO₂/Nb composite 28 via the reactive infiltration of a Nb₂O₅-bearing liquid reactant 22 into a shaped, porous Hf preform 20. The associated pore-filling reaction for this example is:

$$( 2 / 5 ) \{ N {b}_{2} {O}_{5} \} ( 1 ) + H f ( s ) = H f {O}_{2} ( s ) + ( 4 / 5 ) N b ( s ) , \qquad Eq . ( 5 )$$

where {Nb₂O₅}(l) refers a multicomponent oxide liquid reactant 22 that contains Nb₂O₅. Examples of a multicomponent oxide liquid reactant 22 that contains Nb₂O₅ include a CaO—Nb₂O₅ liquid solution (such as a 6 wt. % CaO-94 wt. % Nb₂O₅ composition with a eutectic temperature of 1371° C., or a 26 mole % SrO-74 mole % Nb₂O₅ composition with a eutectic temperature of 1320° C.). For this example, the reaction of Eq. (5) would be conducted: i) above the solidus temperature of the Nb₂O₅-bearing liquid reactant 22 (e.g., above 1371° C. for a 6 wt. % CaO-94 wt. % Nb₂O₅ liquid precursor) and ii) below the melting point of Hf (2231° C.).

Example 5. A fifth nonlimiting example of the method 10 of the present invention is the formation of a HfO₂/Ta composite 28 via the reactive infiltration of a Ta₂O₅ liquid reactant 22 into a shaped, porous Hf preform 20. The associated pore-filling reaction for this example is:

$$( 2 / 5 ) T {a}_{2} {O}_{5} ( 1 ) + H f ( s ) = H f {O}_{2} ( s ) + ( 4 / 5 ) T a ( s ) \qquad Eq . ( 6 )$$

For this example, the reaction of Eq. (6) would be conducted: i) above the solidus temperature of Ta₂O₅ (1872° C.) and ii) below the melting point of the lowest-melting solid phase in reaction (6), which is Hf(s) (melting temperature of 2231° C.). This reaction is quite thermodynamically favored. For example, at 1900° C., the standard Gibbs free energy of reaction, DG°ᵣₓₙ₍₆₎[1900° C.], is −307.2 kJ/mol. The solid reaction products 24 and 26 of this reaction (1 mole of HfO₂(s) and (⅘) moles of Ta(s)) possess a combined volume that is 2.19 times larger than the volume of the solid reactant 20 (1 mole of Hf(s)). (Note: the room temperature molar volumes of monoclinic HfO₂(s), Ta(s) and Hf(s) are 20.82 cm³/mole, 10.88 cm³/mole, and 13.48 cm³/mole, respectively.)

Example 6. A sixth nonlimiting example of the method 10 of present invention is the formation of a HfO₂/Ta composite 28 via the reactive infiltration of a Ta₂O₅-bearing liquid reactant 22 into a shaped, porous Hf preform 20. The associated pore-filling reaction for this example is:

$$( 2 / 5 ) \{ T {a}_{2} {O}_{5} \} ( 1 ) + H f ( s ) = H f {O}_{2} ( s ) + ( 4 / 5 ) T a ( s ) , \qquad Eq . ( 7 )$$

where {Ta₂O₅}(l) refers a multicomponent oxide liquid reactant 22 that contains Ta₂O₅. Examples of a multicomponent oxide liquid reactant 22 that contains Ta₂O₅ include a CaO—Ta₂O₅ liquid solution (such as a 4.5 wt. % CaO-95.5 wt. % Ta₂O₅ composition with a eutectic temperature of 1700° C.). For this example, the reaction of Eq. (7) would be conducted: i) above the solidus temperature of the Nb₂O₅-bearing liquid reactant 22 (e.g., above 1700° C. for a 4.5 wt. % CaO-95.5 wt. % Ta₂O₅ liquid precursor) and ii) below the melting point of Hf (2231° C.).

Example 7. A seventh nonlimiting example of the present invention is the formation of a ZrO₂/Ta composite via the reactive infiltration of a Ta₂O₅-bearing liquid into a shaped, porous Zr preform 20. The associated pore-filling reaction for this example is:

$$( 2 / 5 ) \{ T {a}_{2} {O}_{5} \} ( 1 ) + Z r ( s ) = Z r {O}_{2} ( s ) + ( 4 / 5 ) T a ( s ) \qquad Eq . ( 8 )$$

where {Ta₂O₅}(l) refers a multicomponent oxide liquid reactant 22 that contains Ta₂O₅. Examples of a multicomponent oxide liquid reactant 22 that contains Ta₂O₅ include a CaO—Ta₂O₅ liquid solution (such as a 4.5 wt. % CaO-95.5 wt. % Ta₂O₅ composition with a eutectic temperature of 1700° C.). For this example, the reaction of Eq. (8) would be conducted: i) above the solidus temperature of the Nb₂O₅-bearing liquid reactant 22 (e.g., above 1700° C. for a 4.5 wt. % CaO-95.5 wt. % Ta₂O₅ liquid precursor) and ii) below the melting point of Zr 1855° C.).

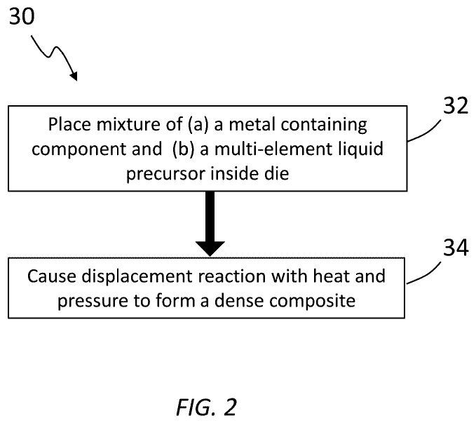

Example 8. FIG. 2 shows a second method 30 of the present invention that includes two basic steps. In a first step 32, a mixture of a metal containing component with a multi-element liquid reactant 22 with an appropriate composition is placed inside a cavity of a high-temperature die with the cavity possessing an appropriate shape of a desired final form. The metal containing component may be a solid metal, a solid metallic alloy, a solid intermetallic compound, or a mixture containing a solid metal reactant. The multi-element liquid reactant 22 may include, but is not limited to, a liquid precursor to a molten oxide, a molten nitride, a molten carbide, a molten boride, and a molten fluoride. At step 34, reaction forming, the mixture is heated to a desired temperature, and a desired pressure is applied so that the following displacement reaction is allowed to partially or completely occur to form a dense composite 28 possessing the shape of the cavity of the high-temperature die:

$$( d / cb ) {M}_{a} {X}_{b} ( 1 ) + N ( s ) = ( 1 / c ) {N}_{c} {X}_{d} ( s ) + ( ad / bc ) M ( s ) , \qquad Eq . ( 9 )$$

where MₐX_{b}(l) is a multi-element liquid reactant 22 (X is a metalloid element, such as, for example, oxygen, nitrogen, carbon, boron, fluorine, etc.); N(s) is a pure metal or is the element N present in a metallic alloy or is the element N present in an intermetallic compound, N_{c}X_{d}(s) is a solid reaction product shape, M(s) is a solid reaction product 26, and a, b, c, and d are molar coefficients. In this method, the metal or metallic alloy or intermetallic compound are provided in an unformed state, such as a powder, granular, or particulate form that has not been formed into the porous preform 20, as in the method 10. Rather, the liquid reactant 22 infiltrates into pores 18 between individual grains or particles, and the mixture is molded into the desired shape of the preform 20, and ultimately the final near-net form factor of the dense composite 28, by the mold cavity itself,

A preferred embodiment of the present invention is that the ceramic-metal composite 28 generated by the methods discussed above is made up of ceramic and metal phases exhibiting similar thermal expansion upon heating to a high temperature and similar thermal contraction upon cooling from a high temperature. Composites 28 formed of such thermal expansion/contraction-matched ceramic and metal phases can exhibit enhanced resistance to thermal cycling (e.g., thermal cycling can be conducted with a reduced or negligible change in fracture strength).

Examples of ceramic-metal composites 28 generated by the methods 10 and 30 above that are made up of ceramic and metal phases with similar thermal expansion upon heating and similar thermal contraction upon cooling include, but are not limited to, ZrO₂/Nb, HfO₂/Nb, ZrO₂/Ta, and HfO₂/Ta composites. The values of thermal expansion of ZrO₂, HfO₂, Nb, and Ta upon heating from 20° C. to 1127° C. (1400 K) are 0.850%, 0.820%, 0.916%, and 0.783%, respectively. Hence for ZrO₂/Nb, HfO₂/Nb, ZrO₂/Ta, and HfO₂/Ta composites, the differences in thermal expansion values of the oxide and metal phases from 20° C. to 1127° C. are only 7.8% (0.916/0.850=1.078), 11.7% (0.916/0.820=1.117), 8.6% (0.850/0.783=1.086), and 4.7% (0.820/0.783=1.047), respectively.

The methods disclosed herein provide for the cost-effective manufacturing of complex-shaped, dense, high-temperature ceramic/metal composites. For example, the methods can be used to convert complex-shaped, 3-D binder-jet-printed porous metal bodies into dense, high-temperature, shape-size-preserved ceramic-metal composites. In some nonlimiting examples, the methods disclosed herein can avoid the use of high-pressure batch processes (such as hot pressing or hot isostatic pressing), and complex-shaped porous metal preforms produced by low-cost forming can be converted into dense, shape/size-preserved ceramic/metal composites via cost-effective reactive melt infiltration.

As previously noted above, though the foregoing detailed description describes certain aspects of one or more particular embodiments of the invention, alternatives could be adopted by one skilled in the art. For example, the composites and components made therefrom could differ in appearance and construction from the embodiments described herein and shown in the drawings, functions of certain components of the composites and components made therefrom could be performed by components of different construction but capable of a similar (though not necessarily equivalent) function, and various materials could be used in the fabrication of the composites and and/or components made therefrom. As such, and again as was previously noted, it should be understood that the invention is not necessarily limited to any particular embodiment described herein or illustrated in the drawings.

1. A method of manufacturing a ceramic-metal composite, the method comprising:
forming a metal containing component into a preform having a desired shape and dimensions with pores therein;
infiltrating the pores in the preform with a multi-element liquid reactant; and
reacting the metal containing component with the multi-element liquid reactant in a displacement reaction at an elevated temperature to form a ceramic-metal composite that is less porous than the preform and having the desired shape and dimensions.

2. The method of claim 1, wherein the displacement reaction is of the type
$$( d / bc ) {M}_{a} {X}_{b} ( 1 ) + N ( s ) = ( 1 / c ) {N}_{c} {X}_{d} ( s ) + ( ad / bc ) M ( s ) ,$$
where MₐX_{b}(l) is the multi-element liquid reactant, N(s) is a solid metal reactant comprising the metal containing component, N_{c}X_{d}(s) is a solid reaction product, X is a metalloid element, M(s) is a solid metal reaction product, and a, b, c, and d are molar coefficients.

3. The method of claim 2, wherein the metalloid element comprises at least one of oxygen, nitrogen, carbon, boron, and fluorine.

4. The method of claim 1, wherein the step of reacting comprises conducting a reaction of the metal containing component with the multi-element liquid reactant at a temperature that is above the solidus temperature of the multi-element liquid reactant and below the solidus temperature of the solid metal reactant.

5. The method of claim 1, wherein the metal containing component comprises one or more of a solid metal, a solid metallic alloy, a solid intermetallic compound, and a solid mixture containing the solid metal reactant.

6. The method of claim 1, wherein the multi-element liquid reactant comprises at least one of a liquid precursor to a molten oxide, a molten oxide, a molten nitride, a molten carbide, a molten boride, and a molten fluoride.

7. The method of claim 1, wherein the step of forming comprises forming a mixture of the metal containing component with the multi-element liquid reactant in a die defining the desired shape and dimensions.

8. The method of claim 7, wherein the metal containing component is provided in the die in at least one of a powder form, granular form, or particulate form.

9. The method of claim 7, wherein the step of reacting comprises simultaneously heating and applying pressure to the mixture inside the die.

10. The method of claim 1, wherein the ceramic-metal composite is a high-melting, stiff, erosion-resistant, fracture-resistant, and plastic-deformation-resistant ceramic-metal composite.

11. A ceramic-metal composite manufactured according to the method of claim 1.

12. A component formed of the ceramic-metal composite of claim 11.

13. The component of claim 12, wherein the component comprises a ceramic-refractory metal composite component suitable for a high-temperature system.

14. The component of claim 13, wherein the high-temperature system comprises a system for at least one of transportation, propulsion, power production, and manufacturing.

15. The component of claim 12, wherein the component comprises at least one of a leading edge of an aircraft or missile or rocket, an engine component of an aircraft or missile or rocket, an engine component of a spacecraft, an engine component of a missile exposed to hypersonic conditions, a high-temperature engine component of a non-hypersonic aircraft, and a high-temperature engine component of a non-hypersonic power production systems.

16. The component of claim 12, wherein the component comprises a turbine blade for at least one of a jet engine and a ground-based power plant.

17. A method of manufacturing a high-temperature component of a high-temperature system, wherein the high-temperature component has a desired shape and dimensions, the method comprising:
forming a metal containing component into a preform with pores therein, wherein the preform has a shape and dimensions that are substantially similar to the desired shape and dimensions of the high-temperature component;
infiltrating the pores in the preform with a multi-element liquid reactant;
reacting the metal containing component with the multi-element liquid reactant in a displacement reaction at an elevated temperature to form a ceramic-metal composite having a shape and dimensions that are substantially similar to the shape and dimensions of the preform; and
fine adjusting the shape and dimensions of the ceramic-metal composite to have the desired shape and dimensions of the high-temperature component.

18. The method of claim 17, wherein the displacement reaction is of the type
$$( d / bc ) {M}_{a} {X}_{b} ( 1 ) + N ( s ) = ( 1 / c ) {N}_{c} {X}_{d} ( s ) + ( ad / bc ) M ( s ) ,$$
where MₐX_{b}(l) is the multi-element liquid reactant, N(s) is a solid metal reactant comprising the metal containing component, N_{c}X_{d}(s) is a solid reaction product, X is a metalloid element, M(s) is a solid metal reaction product, and a, b, c, and d are molar coefficients.

19. The method of claim 17, wherein the step of reacting comprises conducting a reaction of the metal containing component with the multi-element liquid reactant at a temperature that is above the solidus temperature of the multi-element liquid reactant and below the solidus temperature of the solid metal reactant.
